(19) United States
(12) Patent Application Publication
(10) Pub. No.: US 2012/0236345 A1
(43) Pub. Date: Sep. 20, 2012

(54) DEVICE, APPARATUS, AND METHOD OF EXECUTING PROGRAM FROM EXECUTING DEVICE, AND RECORDING MEDIUM STORING EXECUTING CONTROL PROGRAM

(76) Inventor: Daisuke MACHIDA, Kanagawa (JP)

(21) Appl. No.: 13/410,624

(22) Filed: Mar. 2, 2012

(30) Foreign Application Priority Data
Mar. 17, 2011 (JP) 2011-058983

(51) Int. Cl. G06F 3/12

(52) U.S. Cl. 358/1.13

(57) ABSTRACT

An information processing device is provided with a first executing device that stores a program therein for execution by a processor, and a connector that electrically connects the information processing device with a second executing device storing a program therein. When the second executing device is connected, the second executing device is caused to be inaccessible from the processor such that the processor reads the program from the second executing device for execution by the processor.

### CROSS-REFERENCE TO RELATED APPLICATIONS

This patent application is based on and claims priority pursuant to 35 U.S.C. §119 to Japanese Patent Application No. 2011-058983, filed on Mar. 17, 2011, in the Japan Patent Office, the entire disclosure of which is hereby incorporated herein by reference.

### BACKGROUND

1. Field

The present invention generally relates to an information processor capable of executing a program from a selected one of a plurality of executing devices, an image forming apparatus provided with such information processor, and a method of executing a program from a selected one of a plurality of executing devices.

2. Background

The recent information processor may be provided with a plurality of executing devices each storing programs to be executed by the information processor. The order of accessing the executing devices is previously determined such that the order of accessing cannot be changed. To cause the information processor to execute from a specific executing device, a mechanical switch may be provided as described in Japanese Patent Application Publication No. 2010-244460. When a user prefers to execute the information processor from a second executing device that is set to be accessed later, the mechanical switch is turned on to prohibit output of a signal from a central processing unit (CPU) to a first executing device that is set to be accessed first. This causes the CPU to access the second executing device to read programs stored therein for execution.

### SUMMARY

Providing the switch in the information processor, however, requires more space for installation and additional manufacturing costs. In view of this, one aspect of the present invention is to provide an information processor capable of executing a program from a selected one of a plurality of executing devices according to the user preference, without changing the previously set order of accessing the executing devices, and with the reduced installation space and the reduced manufacturing costs.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a cross-sectional view illustrating a structure of an image forming apparatus including an information processor, according to an example embodiment of the present invention;

FIG. 2 is a schematic block diagram illustrating a structure of the information processor of FIG. 1, according to an example embodiment of the present invention;

FIG. 3 is a flowchart illustrating operation of executing programs when the image forming apparatus of FIG. 1 is powered on, performed by the information processor of FIG. 2, according to an example embodiment of the present invention;

FIG. 4 is a schematic block diagram illustrating a structure of the information processor of FIG. 1, according to an example embodiment of the present invention;

FIG. 5 is a flowchart illustrating operation of executing programs when the image forming apparatus of FIG. 1 is powered on, performed by the information processor of FIG. 4, according to an example embodiment of the present invention;

FIG. 6 is a schematic block diagram illustrating a structure of the information processor of FIG. 1, according to an example embodiment of the present invention;

FIG. 7 is a schematic block diagram illustrating a structure of the information processor of FIG. 1, according to an example embodiment of the present invention;

FIG. 8 is a flowchart illustrating operation of executing programs when the image forming apparatus of FIG. 1 is powered on, performed by the information processor of FIG. 7, according to an example embodiment of the present invention;

FIG. 9 is a schematic block diagram illustrating a structure of the information processor of FIG. 1, according to an example embodiment of the present invention;

FIG. 10 is a flowchart illustrating operation of executing programs when the image forming apparatus of FIG. 1 is powered on, performed by the information processor of FIG. 9, according to an example embodiment of the present invention;

FIG. 11 is a schematic block diagram illustrating a structure of the information processor of FIG. 1, according to an example embodiment of the present invention;

FIG. 12 is a flowchart illustrating operation of executing programs when the image forming apparatus of FIG. 1 is powered on, performed by the information processor of FIG. 11, according to an example embodiment of the present invention;

FIG. 13 is a schematic block diagram illustrating a structure of the information processor of FIG. 1, according to an example embodiment of the present invention;

FIG. 14 is a flowchart illustrating operation of executing programs when the image forming apparatus of FIG. 1 is powered on, performed by the information processor of FIG. 13, according to an example embodiment of the present invention;

FIG. 15 is a schematic block diagram illustrating a structure of the information processor of FIG. 1, according to an example embodiment of the present invention;

FIG. 16 is a flowchart illustrating operation of executing programs when the image forming apparatus of FIG. 1 is powered on, performed by the information processor of FIG. 15, according to an example embodiment of the present invention;

FIG. 17 is a schematic block diagram illustrating a structure of the information processor of FIG. 1, according to an example embodiment of the present invention; and

FIG. 18 is a flowchart illustrating operation of executing programs when the image forming apparatus of FIG. 1 is powered on, performed by the information processor of FIG. 17, according to an example embodiment of the present invention.

The accompanying drawings are intended to depict example embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments shown in the drawings, specific terminology is employed for the sake of clarity. However, the present disclosure is not intended to be limited to the specific terminology so selected and it is to be understood that each specific element includes all technical equivalents that operate in a similar manner.

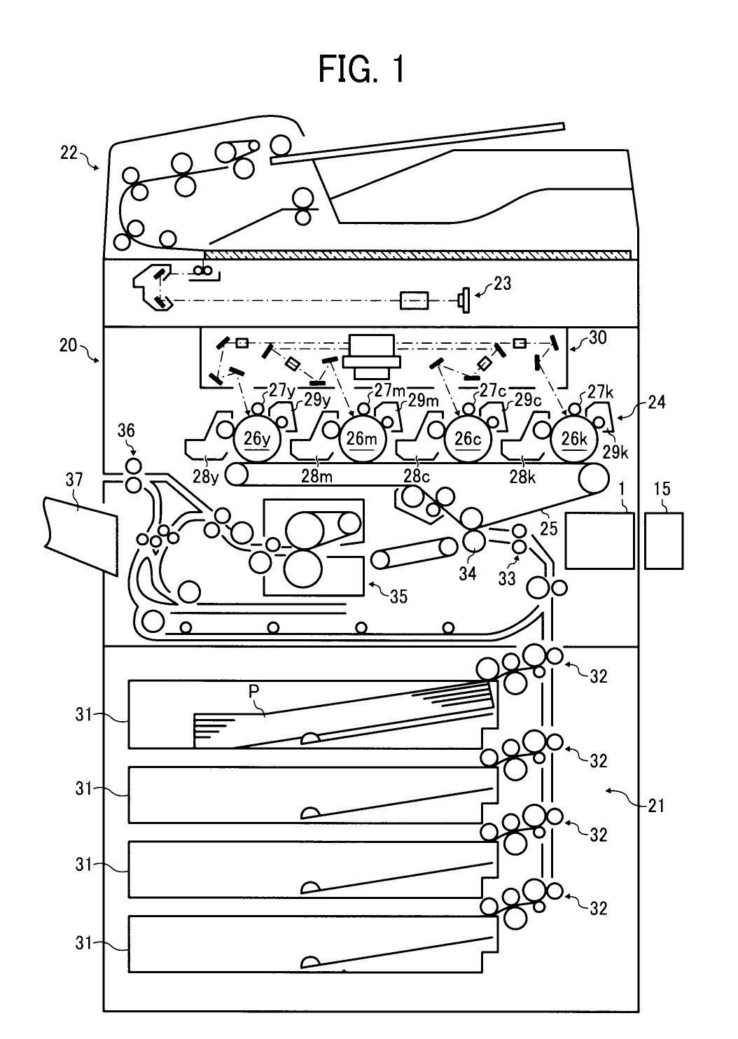

FIG. 1 is a schematic block diagram illustrating a functional structure of a multifunctional apparatus (MFP) 20 according to an example embodiment of the present invention. The MFP 20 is capable of performing various operations including image reading, printing, copying, and transmitting or receiving data. The MFP 20 mainly includes a sheet feeding device 21, an original document transfer device 22, an image reading device 23, and an image forming device 24.

The sheet feeding device 21 includes a plurality of trays 31, and a sheet transfer device 32. In printing or copying operation, the sheet transfer device 32 transfers the recording sheet P, which is fed from one of the plurality of trays 31 of the sheet feeding device 21, to the image forming device 24.

The original document transfer device 22 transfers an original document to the image reading device 23 such that the original document is read by the image reading device 23. For example, the original document transfer device 22 may be implemented by an automatic document feeder.

The image reading device 23 may be implemented by a scanner, which is provided with an optical system including various parts such as a light source and mirrors. The image reading device 23 reads an image of the original document received from the original document transfer device 22 into scanned image data. Alternatively, the image reading device 23 may read an image of the original document that is placed on an exposure glass.

The image forming device 24 includes an intermediate transfer belt 25, and a plurality of photoconductors 26y, 26m, 26c, and 26k which are arranged side by side along the surface of the intermediate transfer belt 25.

The photoconductor 26y functions as an image carrier on which a toner image of yellow is formed on its surface. The yellow toner image is further transferred from the surface of the photoconductor 26y to the intermediate transfer belt 25.

The photoconductor 26m functions as an image carrier on which a toner image of magenta is formed on it surface. The magenta toner image is further transferred from the surface of the photoconductor 26m to the intermediate transfer belt 25.

The photoconductor 26c functions as an image carrier on which a toner image of cyan is formed on its surface. The cyan toner image is further transferred from the surface of the photoconductor 26c to the intermediate transfer belt 25.

The photoconductor 26k functions as an image carrier on which a toner image of black is formed on its surface. The black toner image is further transferred from the surface of the photoconductor 26k to the intermediate transfer belt 25. The photoconductors 26y, 26m, 26c, and 26k may be collectively referred to as the photoconductor 26.

In case of forming a full-color toner image, the toner images of respective colors of yellow, magenta, cyan, and black are transferred to the intermediate transfer belt 25 such that the toner images are superimposed one above the other to form a composite toner image thereon. In case of forming a monochrome image, or a black color image, the black toner image formed on the surface of the photoconductor 26k is transferred to the intermediate transfer belt 25 to form a monochrome toner image thereon. The composite toner image or the monochrome toner image is further transferred by the intermediate transfer belt 25, which functions as a transfer body, toward a fixing device 35.

The image forming device 24 further includes a plurality of charging devices 27y, 27m, 27c, and 27k (collectively referred to as the charging device 27), a plurality of developing devices 28y, 28m, 28c, and 28k (collectively referred to as the developing device 28), a plurality of cleaning devices 29y, 29m, 29c, and 29k (collectively referred to as the cleaning device 29), and an exposure device 30. More specifically, for the photoconductor 26, the charging device 27, the developing device 28, and the cleaning device 29 are provided in a circumferential direction of the photoconductor 26. The charging device 27 charges the surface of the photoconductor 26. The developing device 28 develops a latent image formed on the surface of the photoconductor 26 with toner into a toner image. After the toner image is transferred from the surface of the photoconductor 26 to the intermediate transfer belt 25, the cleaning device 29 removes residual toner from the surface of the photoconductor 26. The exposure device 30 includes a light exposure system having a plurality of mirrors and lenses, which causes a plurality of latent images to be formed on the respective surfaces of the photoconductors 26y to 26k according to image data such as scanned image data.

The recording sheet P that is transferred by the transfer device 32 from the tray 31 of the sheet feeding device 21 is stopped at the registration roller pair 33. The recording sheet P is transferred from the registration roller pair 33 at a predetermined time to be in synchronization with rotation of the intermediate transfer belt 25. When the recording sheet P reaches a nip formed between a transfer roller 34 and the intermediate transfer belt 25, the toner image is transferred from the intermediate transfer belt 25 onto the recording sheet P. The recording sheet P formed with the toner image is further transferred to the fixing device 35. The recording sheet P having the toner image fixed thereon is discharged through a discharge roller pair 36 onto an output tray 37.

In scanning operation, the MFP 20 reads an original document into scanned image data using the image reading device 23. In copying operation, the MFP 20 reads an original document into scanned image data using the image reading device 23, and further prints an image based on the scanned image data on a recording sheet P using the image forming device 24. In printing operation, the MFP 20 receives image data from an external apparatus such as an information processing apparatus or an image forming apparatus through a network using a communication device, and further prints an image based on the received image data on a recording sheet P using the image forming device 24.

The MFP 20 is further provided with a memory, which stores various image data including the scanned image data read by the image reading device 23, or the received image data received from the external apparatus. In data communication operation, the MFP 20 transfers image data to the external apparatus through the network using the communication device. The network may be a facsimile network or the Internet. Alternatively, the MFP 20 may receive image data from the external apparatus through the network using the communication device.

The MFP 20 is provided with an information processor 1, which is capable of executing programs from a selected one of a plurality of executing devices. More specifically, as described below, the information processor 1 includes an executing device, which is interlay provided in the information processor 1, such as a nonvolatile memory or a hard disk drive (HDD) storing therein various programs to be executed by the information processor 1. Additionally, the information processor 1 includes a connector to which a removable executing device 15 is connected. The information processor 1 is caused to select one of the executing devices, and read various programs from the selected executing device to perform operations according to the read programs.

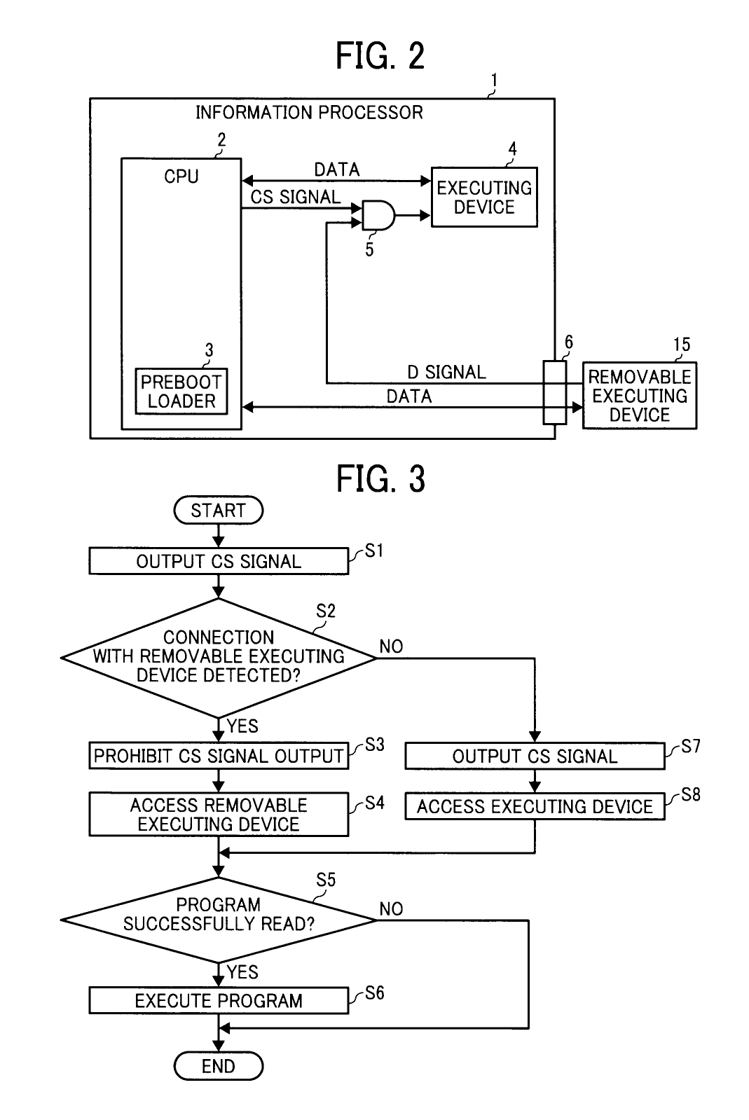

Referring now to FIGS. 2 and 3, one example of the information processor 1 is explained. FIG. 2 is a schematic block diagram illustrating a structure of the image processor 1. FIG. 3 is a flowchart illustrating operation of executing a program when the information processor 1 is turned on, performed by the information processor 1 of FIG. 2, according to an example embodiment of the present invention.

As illustrated in FIG. 2, the information processor 1 includes a central processing unit (CPU) 2, a preboot loader 3 that is an internal function of the CPU 2, an executing device 4, a logic integrated circuit (IC) 5, and a connector 6. Through the connector 6, a removable executing device 15 is connected to the information processor 1.

The CPU 2 is a microprocessor, which functions as a controller that reads various programs from the executing device 4 or the removable executing device 15 using the preboot loader 3, and executes the read programs to perform various operations. Examples of programs include, but not limited to, an operating system (OS) program that controls entire operation of the MFP 20, and application programs that cause the MFP 20 to perform reading, copying, printing, and communicating as described above referring to FIG. 1.

The preboot loader 3 is a device, which stores therein settings information indicating an order of accessing the executing devices in a manner that is not rewritable. The settings information may be set in terms of BIOS settings or the external terminal settings of the CPU 2. In this example, the settings information indicates that the executing device 4 is to be accessed first, and the removable executing device 15 to be accessed second. The preboot loader 3 may be provided within the CPU 2 as illustrated in FIG. 2, or outside the CPU 2. Further, in addition to the executing device 4, one or more executing devices may be provided in the information processor 1, which may be executed in the order specified by the settings information stored in the preboot loader 3. When the power of the MFP 20 is turned on, the preboot loader 3 firstly accesses the executing device 4 to read the programs stored therein. When the executing device 4 cannot be accessed, the preboot loader 3 accesses the removable executing device 15, which is connected through the connector 6, to read the programs stored therein.

The executing device 4 includes a nonvolatile memory such as a read only memory (ROM), a random access memory (RAM), and a hard disk drive (HDD). The executing device 4 stores therein the programs to be executed on the MFP 20.

The logic IC 5 detects connection or disconnection of the removable executing device 15 through the connector 6. For example, the logic IC 5 determines that the removable executing device 15 is connected when a detect signal indicating connection is detected. As the power of the MFP 20 is turned on, when the logic IC 5 detects that the removable executing device 15 is connected through the connector 6, the logic IC 5 causes the executing device 4 to be inaccessible from the preboot loader 3. More specifically, as described below, the logic IC 5, which receives a chip select signal from the CPU 2, prohibits output of the CS signal to the executing device 4. Since the executing device 4, which does not receive the CS signal, does not return an expected value to the CPU 2, the CPU 2 assumes that the executing device 4 is not accessible. When the executing device 4 is inaccessible, the CPU 2 accesses the removable executing device 15.

The connector 6 electrically connects the removable executing device 15 to the information processor 1. For example, the connector 6 may be implemented by an outside device interface, which allows a removable memory to be connected to the information processor 1 or the MFP 20 such that data stored therein is read by the information processor 1.

The removable executing device 15 is implemented by a nonvolatile memory, which may be attached to or removed from the information processor 1 through the connector 6, such as a universal serial bus (USB) memory or a flash memory. The removable executing device 15 stores therein various programs including an OS program that controls entire operation of the MFP 20, and various application programs to cause the MFP 20 to perform image reading, copying, printing, and communicating, etc.

Referring now to FIG. 3, operation of executing a program when the power of the MFP 20 is turned on, performed by the information processor 1 of FIG. 2, is explained according to an example embodiment of the present invention.

When the power of the MFP 20 is turned on, at S1, the CPU 2 of the information processor 1 outputs a chip select (CS) signal to the logic IC 5. The CS signal is asserted to indicate selection of the executing device 4.

At S2, the logic IC 5 determines whether the removable executing device 15 is connected through the connector 6, based on a detect (D) signal output from the connector 6. When the D signal indicating connection of the removable executing device 15 is detected, the logic IC 5 determines that the removable executing device 15 is connected (“YES” at S2), and the operation proceeds to S3. When the D signal indicating connection of the removable executing device 15 is not detected, the logic IC 5 determines that the removable executing device 15 is not connected (“NO” at S2), and the operation proceeds to S7.

At S3, the logic IC 5 prohibits the CS signal, which is received from the CPU 2, from being output to the executing device 4. This makes the executing device 4 to be inaccessible from the preboot loader 3.

At S4, the preboot loader 3, which cannot access the executing device 4, accesses the removable executing device 15. For example, the preboot loader 3 outputs an access signal to the removable executing device 15. It is assumed that an expected value is returned to the CPU 2.

At S7, the logic IC 5 allows the CS signal, which is received from the CPU 2, to be output to the executing device 4 to make the executing device 4 to be accessible from the preboot loader 3.

At S8, the preboot loader 3, which can access the executing device 4, accesses the executing device 4. For example, the preboot loader 3 outputs an access signal to the executing device 4. It is assumed that an expected value is returned to the CPU 2.

At S5, the preboot loader 3 determines whether the programs to be executed by the CPU 2 are successfully read from the executing device 4 or the removable executing device 15. When it is determined that the programs are successfully read (“YES” at S5), the operation proceeds to S6. At S6, the CPU 2 executes the programs read by the preboot loader 3 to perform operations according to the executed programs, and the operation ends. When it is determined that the programs are not successfully read (“NO” at S5), the operation ends in error. In such case, the MFP 20 is not executed.

As described above, when the removable executing device 15 is connected to the information processor 1, as the power of the MFP 20 is turned on, the preboot loader 3 is caused to automatically access the removable executing device 15 even when the preboot loader 3 is programmed to firstly access the executing device 4. For example, when a user has a specific start-up program to be executed by the MFP 20, as long as the user attaches the removable executing device 15 storing the specific program through the connector 6, the MFP 20 automatically executes the MFP 20 with the specific program. This eliminates the needs for additionally providing a mechanical switch that switches among a plurality of executing devices, thus reducing the overall apparatus size and the overall manufacturing costs of the MFP 20.

In case an error is detected in at least one of the programs stored in the executing device 4 such as the OS program or the application programs, the information processor 1 is able to execute the MFP 20 by reading the programs from the removable executing device 15. Further, in case of updating at least one of the programs stored in the executing device 4 such as the OS program or the application programs, the information processor 1 is able to execute the MFP 20 by reading the programs from the removable executing device 15 while updating the programs stored in the executing device 4.

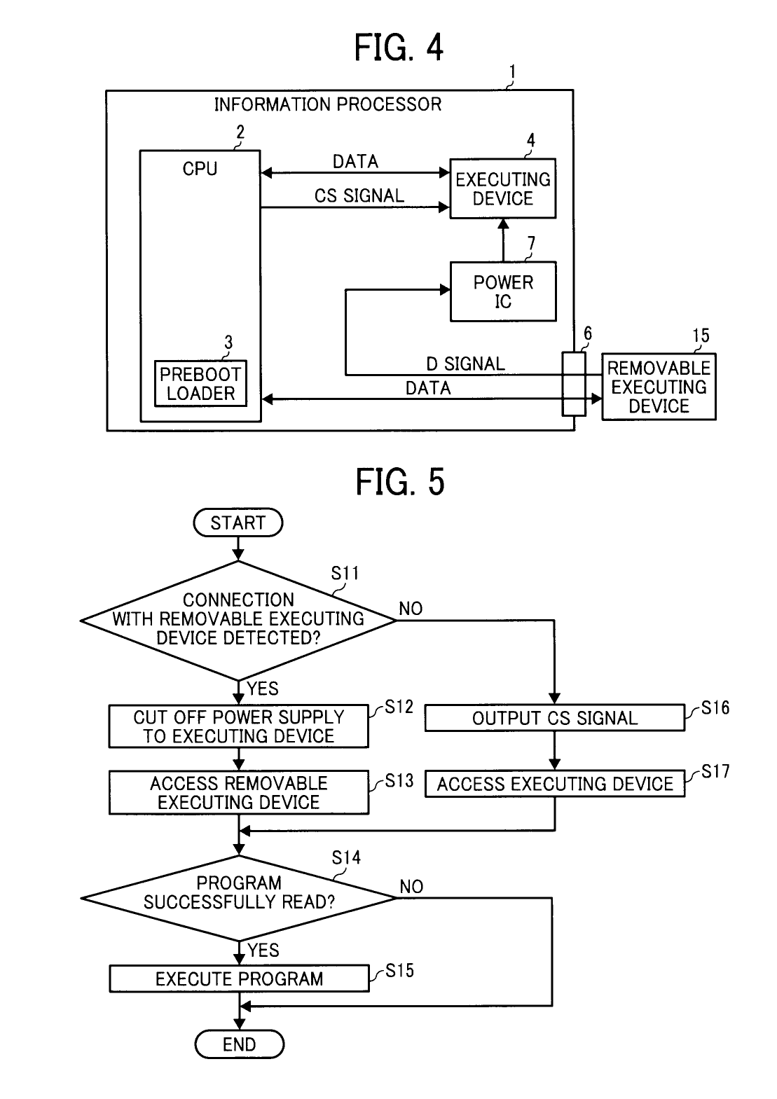

Referring now to FIGS. 4 and 5, one example of the information processor 1 is explained. FIG. 4 is a schematic block diagram illustrating a structure of the image processor 1. FIG. 5 is a flowchart illustrating operation of executing a program when the MFP 20 is turned on, performed by the information processor 1 of FIG. 4, according to an example embodiment of the present invention.

As illustrated in FIG. 4, the information processor 1 includes the CPU 2, the preboot loader 3 that is an internal function of the CPU 2, the executing device 4, and the connector 6. Through the connector 6, the removable executing device 15 is connected to the information processor 1. In this example, in replace of the logic IC 5 of FIG. 2, a power IC 7 is provided.

The CPU 2, the preboot loader 3, the executing device 4, the connector 6, and the removable executing device 15 are substantially similar in function and operation to the preboot loader 3, the executing device 4, the connector 6, and the removable executing device 15 of FIG. 2.

The power IC 7 detects connection or disconnection of the removable executing device 15 through the connector 6. As the power of the MFP 20 is turned on, when the power IC 7 detects the removable executing device 15 is connected through the connector 6, the power IC 7 cuts off electric power supplied form a power source to the executing device 4, thus causing the executing device 4 to be inoperable. This further causes the executing device 4 to be inaccessible from the preboot loader 3.

Referring now to FIG. 5, operation of executing a program when the power of the MFP 20 is turned on, performed by the information processor 1 of FIG. 4, is explained according to an example embodiment of the present invention.

When the power of the MFP 20 is turned on, at S11, the power IC 7 determines whether the removable executing device 15 is connected through the connector 6, based on a detect (D) signal output from the connector 6. When the D signal indicating connection of the removable executing device 15 is detected, the power IC 7 determines that the removable executing device 15 is connected (“YES” at S11), and the operation proceeds to S12. When the D signal indicating connection of the removable executing device 15 is not detected, the power IC 7 determines that the removable executing device 15 is not connected (“NO” at S11), and the operation proceeds to S16.

At S12, the power IC 7 cuts off electric power supply to the executing device 4 to cause the executing device 4 to be inoperable. This makes the executing device 4 to be inaccessible from the preboot loader 3.

At S13, the preboot loader 3, which cannot access the executing device 4, accesses the removable executing device 15. At this time, even though the CS signal indicating selection of the executing device 4 is output, the preboot loader 3 accesses the executing device 15 as the executing device 4 is not accessible.

At S16, the preboot loader 3 outputs the CS signal to the executing device 4 to cause the executing device 4 to be firstly accessed. More specifically, the CS signal is asserted to indicate selection of the executing device 4.

At S17, the preboot loader 3, which can access the executing device 4, accesses the executing device 4.

At S14, the preboot loader 3 determines whether the programs to be executed by the CPU 2 are successfully read from the executing device 4 or the removable executing device 15. When it is determined that the programs are successfully read (“YES” at S14), the operation proceeds to S15. At S15, the CPU 2 executes the programs read by the preboot loader 3 to perform operations according to the executed programs, and the operation ends. When it is determined that the programs are not successfully read (“NO” at S 14), the operation ends in error. In such case, the MFP 20 is not executed.

As described above, when the removable executing device 15 is connected to the information processor 1, as the power of the MFP 20 is turned on, the preboot loader 3 is caused to automatically access the removable executing device 15 even when the preboot loader 3 is programmed to firstly access the executing device 4. More specifically, when connection of the removable executing device 15 is detected, electric power supply to the executing device 4 is cut off, thus causing the executing device 4 to be inaccessible from the preboot loader 3. This eliminates the needs for additionally providing a mechanical switch that switches among a plurality of executing devices, thus reducing the overall apparatus size and the overall manufacturing costs of the MFP 20.

In case an error is detected in at least one of the programs stored in the executing device 4 such as the OS program or the application programs, the information processor 1 is able to execute the MFP 20 by reading the programs from the removable executing device 15. Further, in case of updating at least one of the programs stored in the executing device 4 such as the OS program or the application programs, the information processor 1 is able to execute the MFP 20 by reading the programs from the removable executing device 15 while updating the programs stored in the executing device 4.

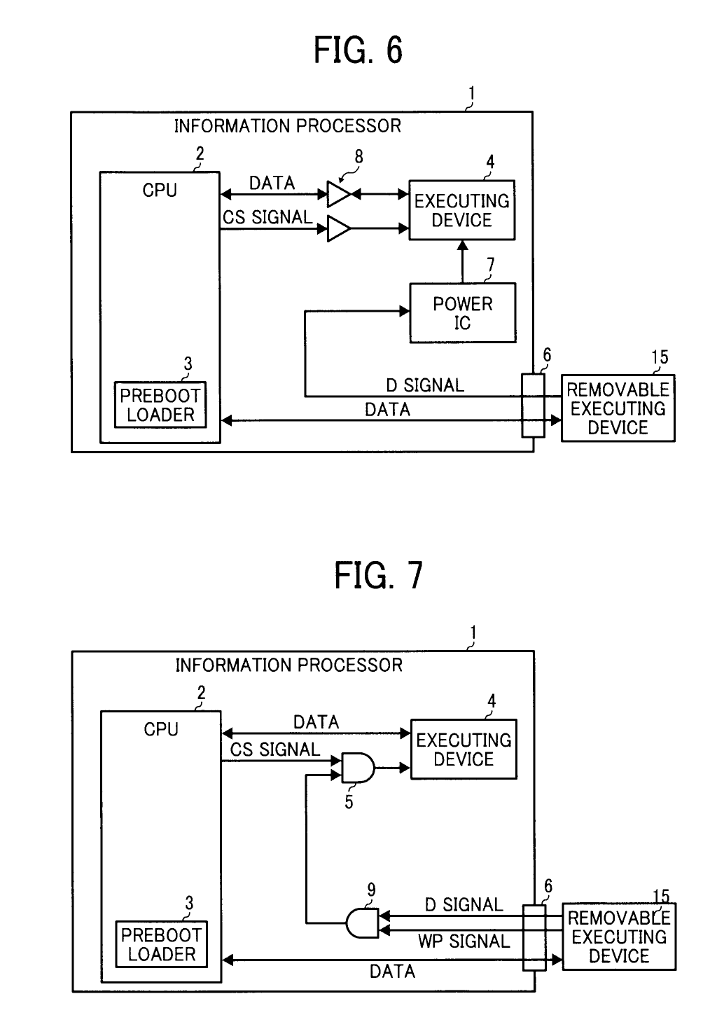

Referring now to FIGS. 6 and 7, one example of the information processor 1 is explained. FIG. 6 is a schematic block diagram illustrating a structure of the image processor 1. FIG. 7 is a flowchart illustrating operation of executing a program when the MFP 20 is turned on, performed by the information processor 1 of FIG. 6, according to an example embodiment of the present invention.

The information processor 1 of FIG. 6 is substantially similar in function and operation to the information processor 1 of FIG. 4, except for the differences that include addition of a buffer 8.

As described above referring to FIGS. 4 and 5, the information processor 1 is caused to automatically access the removable executing device 15, by cutting off the electric power supply to the executing device 4 that is programmed to be firstly accessed. If the executing device 4 is not provided with a partial power down function, electric currents may flow into the executing device 4 as voltages that are higher than the source voltage are applied to an input/output terminal of the executing device 4. This may damage the executing device 4.

In view of this, the information processor 1 of FIG. 6 is provided with the buffer 8 having the partial power down function, between the CPU 2 and the executing device 4. Even when the executing device 4 is not provided with the partial power down function, the buffer 8 prevents electric currents from flowing into the executing device 4 as electric power supply is cut, thus preventing the damages to the executing device 4.

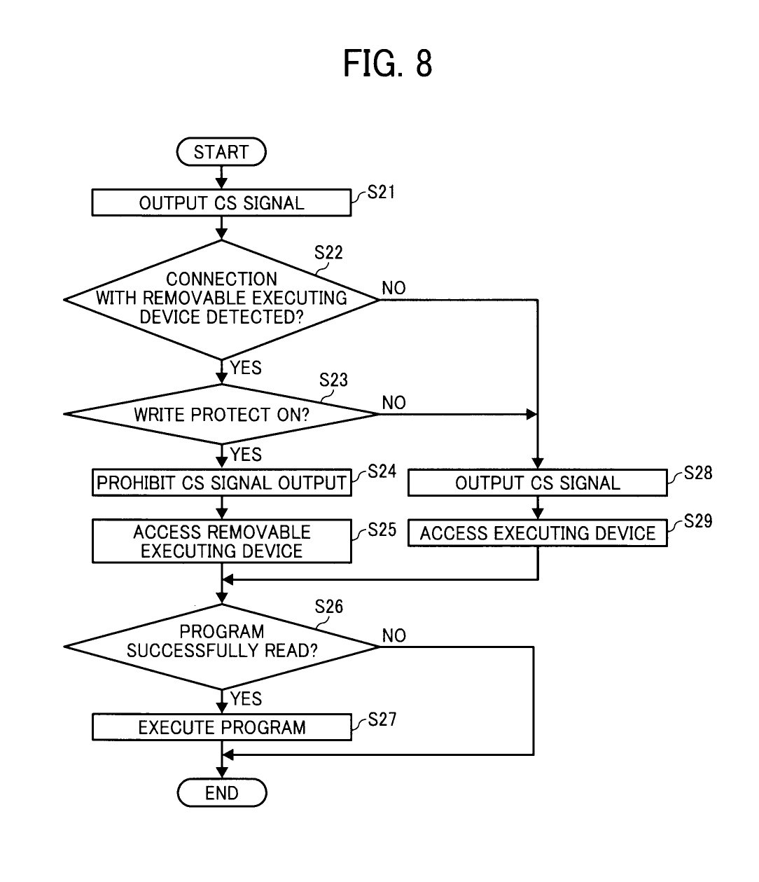

Referring now to FIGS. 7 and 8, one example of the information processor 1 is explained. FIG. 7 is a schematic block diagram illustrating a structure of the image processor 1. FIG. 8 is a flowchart illustrating operation of executing a program when the MFP 20 is turned on, performed by the information processor 1 of FIG. 7, according to an example embodiment of the present invention.

In the information processor 1 of FIGS. 2, 4, and 6, any user is able to cause the MFP 20 to execute with the programs stored in the removable executing device 15, even though the MFP 20 may require the user to be authorized before using the MFP 20. Especially when the removable executing device 15 is used to rewrite or update the programs stored in the MFP 20, it is preferable to prevent an unauthorized user from executing the MFP 20 with the programs stored in the removable executing device 15. More specifically, it is preferable to cause the information processor 1 to execute with the programs read from the removable executing device 15 only when the removable executing device 15 is provided from an authorized user, with a simple structure.

The information processor 1 of FIG. 7 allows execution from the removable executing device 15 only when the removable executing device 15 is set such that it is not writable. In such case, an authorized user is expected to set the write protect of the removable executing device 15 to ON, before connecting the removable executing device 15 to the information processor 1.

As illustrated in FIG. 7, the information processor 1 includes the CPU 2, the preboot loader 3 that is an internal function of the CPU 2, the executing device 4, the logic IC 5, and the connector 6. Through the connector 6, the removable executing device 15 is connected to the information processor 1. The information processor 1 further includes a logic IC 9.

The CPU 2, the preboot loader 3, the executing device 4, the logic IC 5, the connector 6, and the removable executing device 15 are substantially similar in function and operation to the CPU 2, the preboot loader 3, the executing device 4, the logic IC 5, the connector 6, and the removable executing device 15 of FIG. 2.

The logic IC 9 determines whether the removable executing device 15 is set such that it is not writable. When the removable executing device 15 is connected through the connector 6 as the power of the MFP 20 is turned on, the logic IC 9 determines whether a write protect (WP) signal indicating that the removable executing device 15 is not writable is output. Based on the output of the WP signal, the logic IC 9 determines that the removable executing device 15 is not writable.

When it is determined that the WP signal indicating that the removable executing device 15 is not writable is output, the logic IC 9 outputs a detect (D) signal to the logic IC 5 to instruct the logic IC 5 to cause the executing device 4 to be inaccessible. When it is determined that the WP signal indicating that the removable executing device 15 is not writable is not output, the logic IC 9 does not output the D signal to the logic IC 5 such that the executing device 4 is accessible.

Referring now to FIG. 8, operation of executing a program when the power of the MFP 20 is turned on, performed by the information processor 1 of FIG. 7, is explained according to an example embodiment of the present invention.

When the power of the MFP 20 is turned on, at S21, the preboot loader 3 outputs the CS signal indicating selection of the executing device 4 to the logic IC 5.

At S22, the logic IC 9 determines whether the removable executing device 15 is connected through the connector 6, based on a detect (D) signal output from the connector 6. When the D signal indicating connection of the removable executing device 15 is detected, the logic IC 9 determines that the removable executing device 15 is connected (“YES” at S22), and the operation proceeds to S23. When the D signal indicating connection of the removable executing device 15 is not detected, the logic IC 9 determines that the removable executing device 15 is not connected (“NO” at S22), and the operation proceeds to S28.

At S23, the logic IC 9 determines whether the removable executing device 15 is set to be “not writable”, or the write protect of the removable executing device 15 is set to ON, based on the WP signal output from the connector 6. When the WP signal indicating that the write protect is set to ON is detected, the logic IC 9 determines that the removable executing device 15 is set to be not writable (“YES” at S23), and the operation proceeds to S24. At S24, the logic IC 9 instructs the logic IC 5 to prohibit the CS signal from being output to the executing device 4 by sending the D signal to the logic IC 5.

More specifically, at S24, when the logic IC 5 detects the D signal, which is output from the connector 6 through the logic IC 9 as the removable executing device 15 is connected, the logic IC 5 determines that the removable executing device 15 is connected, and prohibits the CS signal received from the CPU 2 from being output to the executing device 4. This causes the executing device 4 to be inaccessible from the preboot loader 3.

At S25, the preboot loader 3, which cannot access the executing device 4, accesses the removable executing device 15.

When the WP signal indicating that the write protect is set to ON is not detected, the logic IC 9 determines that the removable executing device 15 is not set to be writable (“NO” at S23), and the operation proceeds to S28. At S28, the logic IC 9 does not output the D signal such that the logic IC 5 outputs the CS signal to the executing device 4.

More specifically, at S28, when the logic IC 5 does not receive the D signal, which is output from the connector 6 through the logic IC 9 when the removable executing device 15 is connected, the logic IC 5 determines that the removable executing device 15 is not connected, and outputs the CS signal to the executing device 4. This causes the executing device 4 to be accessible from the preboot loader 3.

At S29, the preboot loader 3, which can access the executing device 4, accesses the executing device 4.

At S26, the preboot loader 3 determines whether the programs to be executed by the CPU 2 are successfully read from the executing device 4 or the removable executing device 15. When it is determined that the programs are successfully read (“YES” at S26), the operation proceeds to S27. At S27, the CPU 2 executes the programs read by the preboot loader 3 to perform operations according to the executed programs, and the operation ends. When it is determined that the programs are not successfully read (“NO” at S26), the operation ends in error. In such case, the MFP 20 is not executed.

In the example described above referring to FIGS. 7 and 8, the logic IC 9 is provided in addition to the circuits illustrated in FIG. 2. In a substantially similar manner, any one of the information processor 1 of FIG. 4 and the information processor 1 of FIG. 6 may be each provided with the logic IC 9 of FIG. 7. In such case, the power IC 7 operates in a substantially similar manner as the logic IC 5 of FIG. 7 operates. When the power IC 7 detects the D signal indicating connection of the removable executing device 15, which is received from the connector 6 through the logic IC 9 when the WP signal indicating that write protect is ON is detected, the power IC 7 cuts off electric power supply to the executing device 4 to cause the executing device 4 to be inaccessible from the preboot loader 3. This causes the preboot loader 3 to access the removable executing device 15.

As described above referring to FIGS. 7 and 8, the preboot loader 3 accesses the removable executing device 15 only when the removable executing device 15 that is set to be not writable, i.e., the write protect is set to ON, is connected to the connector 6. The unauthorized user, who is not most likely to know that the write protect of the removable executing device 15 should be set to ON, is not able to cause the information processor 1 to execute with the programs stored in the removable executing device 15. This suppresses the unauthorized use of the information processor 1 or the MFP 20.

Further, since the removable executing device 15, such as the USB memory, is usually provided with the write protect function, there is no need to change a structure of the removable executing device 15. Similarly, since the information processor 1 or the MFP 20 is usually provided with the function of detecting the WP signal, the information processor 1 of FIG. 7 can be implemented with relatively low costs.

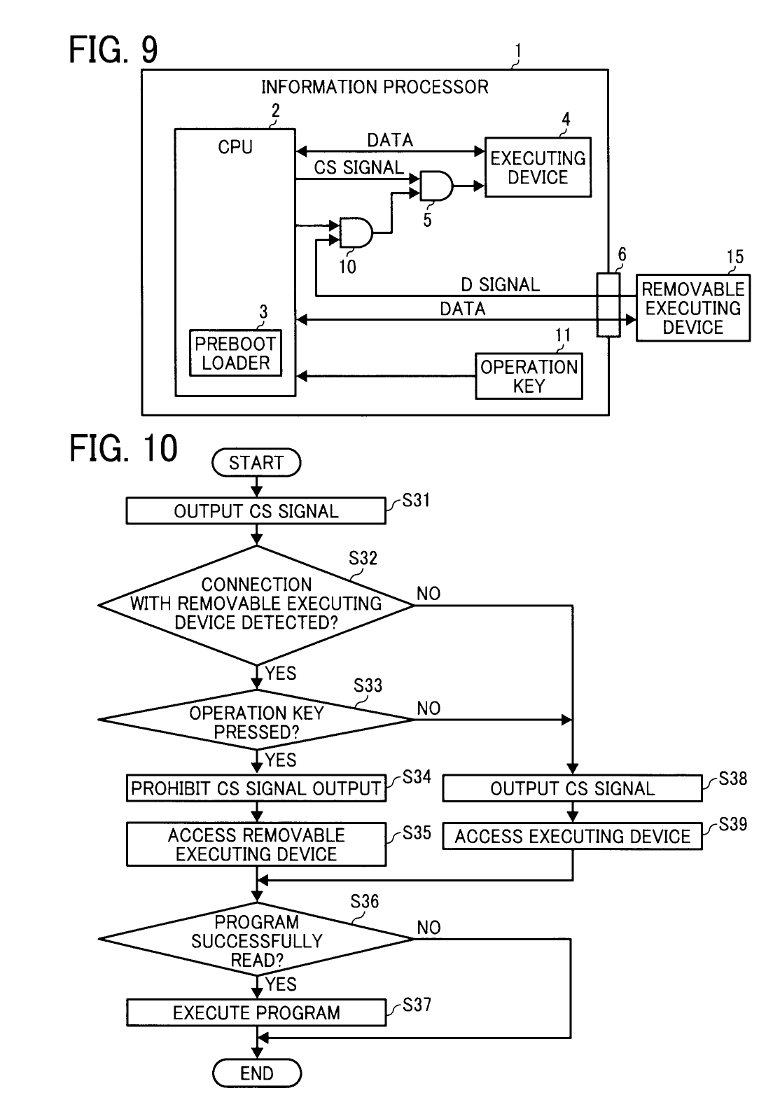

Referring now to FIGS. 9 and 10, one example of the information processor 1 is explained. FIG. 9 is a schematic block diagram illustrating a structure of the image processor 1. FIG. 10 is a flowchart illustrating operation of executing a program when the MFP 20 is turned on, performed by the information processor 1 of FIG. 9, according to an example embodiment of the present invention.

In the above-described example referring to FIGS. 7 and 8, the information processor 1 causes the MFP 20 to execute with the programs read from the removable executing device 15 when the removable executing device 15 having the write protect being set to ON is connected. Alternatively or additionally, in this example, the information processor 1 causes the MFP 20 to execute with the programs read from the removable executing device 15 when a specific operation key provided on the MFP 20 is input when the power of the MFP 20 is turned on.

In this example, an authorized user is expected to connect the removable executing device 15 to the information processor 1, and inputs a specific operation key, while turning on the power of the MFP 20. For example, the specific operation key may be set to “#” key of the ten-key of the MFP 20. Alternatively, the specific operation key may be set to more than one key.

As illustrated in FIG. 9, the information processor 1 includes the CPU 2, the preboot loader 3 that is an internal function of the CPU 2, the executing device 4, the logic IC 5, and the connector 6. Through the connector 6, the removable executing device 15 is connected to the information processor 1. The information processor 1 further includes a logic IC 10, and an operation key 11. FIG. 9 shows that the operation key 11 is provided in the information processor 1. However, the operation key 11 may be one or more of the keys that are included in an operation panel of the MFP 20.

The CPU 2, the preboot loader 3, the executing device 4, the logic IC 5, the connector 6, and the removable executing device 15 are substantially similar in function and operation to the preboot loader 3, the executing device 4, the logic IC 5, the connector 6, and the removable executing device 15 of FIG. 2.

The logic IC 10 detects connection or disconnection of the removable executing device 15 through the connector 6. As the power of the MFP 20 is turned on, the logic IC 10 determines whether a detect (D) signal is output, which is the signal output from the connector 6 when the removable executing device 15 is connected to the connector 6. Further, the logic IC 10 determines whether to allow execution from the removable executing device 15 based on a signal output from the CPU 2 when the operation key 11 is pressed.

When the logic IC 10 detects the signal indicating that the operation key 11 is pressed, the logic IC 10 outputs the D signal, which is received from the connector 6, to the logic IC 5 to instruct the logic IC 5 to prohibit output of the CS signal to the executing device 4. This causes the executing device 4 to be inaccessible from the preboot loader 3.

When the logic IC 10 does not detect the signal indicating that the operation key 11 is pressed, the logic IC 10 does not output the D signal, which is received from the connector 6, to the logic IC 5. The logic IC 5 outputs the CS signal to the executing device 4 to allow the executing device 4 to be accessible from the reboot loader 3.

Referring now to FIG. 10, operation of executing a program when the power of the MFP 20 is turned on, performed by the information processor 1 of FIG. 9, is explained according to an example embodiment of the present invention.

When the power of the MFP 20 is turned on, at S31, the preboot loader 3 outputs the CS signal indicating selection of the executing device 4 to the logic IC 5.

At S32, the logic IC 10 determines whether the removable executing device 15 is connected through the connector 6, based on the D signal output from the connector 6. When the D signal indicating connection of the removable executing device 15 is detected, the logic IC 10 determines that the removable executing device 15 is connected (“YES” at S32), and the operation proceeds to S33. When the D signal indicating connection of the removable executing device 15 is not detected, the logic IC 10 determines that the removable executing device 15 is not connected (“NO” at S32), and the operation proceeds to S38.

At S33, the logic IC 10 determines whether the specific operation key 11 is pressed, based on the signal indicating that the specific operation key 11 is pressed. When the signal indicating that the specific operation key 11 is pressed is detected, the logic IC 10 determines that the specific operation key 11 is pressed (“YES” at S33), and the operation proceeds to S34. When the signal indicating that the specific operation key 11 is pressed is not detected, the logic IC 10 determines that the specific operation key 11 is not pressed (“NO” at S33), and the operation proceeds to S38.

At S34, the logic IC 10 outputs the D signal, which is received from the connector 6, to the logic IC 5 to instruct the logic IC 5 to prohibit the CS signal from being output to the executing device 4, thus causing the executing device 4 to be inaccessible from the preboot loader 3.

At S35, the preboot loader 3, which cannot access the executing device 4, accesses the removable executing device 15.

At S38, the logic IC 10 does not output the D signal, which is received fro the connector 6, to the logic IC 5. Since the D signal is not detected, the logic IC 5 assumes that the removable executing device 15 is not connected, and outputs the CS signal to the executing device 4. This causes the executing device 4 to be accessible from the preboot loader 3.

At S39, the preboot loader 2, which can access the executing device 4, accesses the executing device 4.

At S36, the preboot loader 3 determines whether the programs to be executed by the CPU 2 are successfully read from the executing device 4 or the removable executing device 15. When it is determined that the programs are successfully read (“YES” at S36), the operation proceeds to S37. At S37, the CPU 2 executes the programs read by the preboot loader 3 to perform operations according to the executed programs, and the operation ends. When it is determined that the programs are not successfully read (“NO” at S36), the operation ends in error. In such case, the MFP 20 is not executed.

In the above-described example referring to FIGS. 9 and 10, the logic IC 10 is additionally provided to the information processor 1 of FIG. 2. Alternatively, the information processor 1 of any one of FIGS. 4 and 6 may be additionally provided with the logic ID 10. In such case, when the power supply IC 7 detects the D signal indicating connection of the removable executing device 15, which is received from the connector 6 through the logic IC 10 when the signal indicating that the operation key 11 is pressed is detected, the power supply IC 7 cuts off electric power supply to the executing device 4 to cause the executing device 4 to be inaccessible from the preboot loader 3. This causes the preboot loader 3 to access the removable executing device 15 to read programs stored therein.

As described above referring to FIGS. 9 and 10, the preboot loader 3 accesses the removable executing device 15 only when the operation key 11 is pressed as the power of the MFP 20 is turned on. The unauthorized user, who is not most likely to know that the specific operation key 11 should be pressed, is not able to cause the information processor 1 to execute with the programs stored in the removable executing device 15. This suppresses the unauthorized use of the information processor 1 or the MFP 20.

Further, since the operation key 11 is previously provided on the information processor 1 or the MFP 20, there is no need to change a hardware structure of the information processor 1 or the MFP 20, thus reducing the overall manufacturing costs.

Alternatively, the logic IC 10 may be additionally provided to the information processor 1 of FIG. 7. In such case, the logic IC 5 detects the D signal only when the write protect of the removable executing device 15 is set to ON and the operation key 11 is pressed.

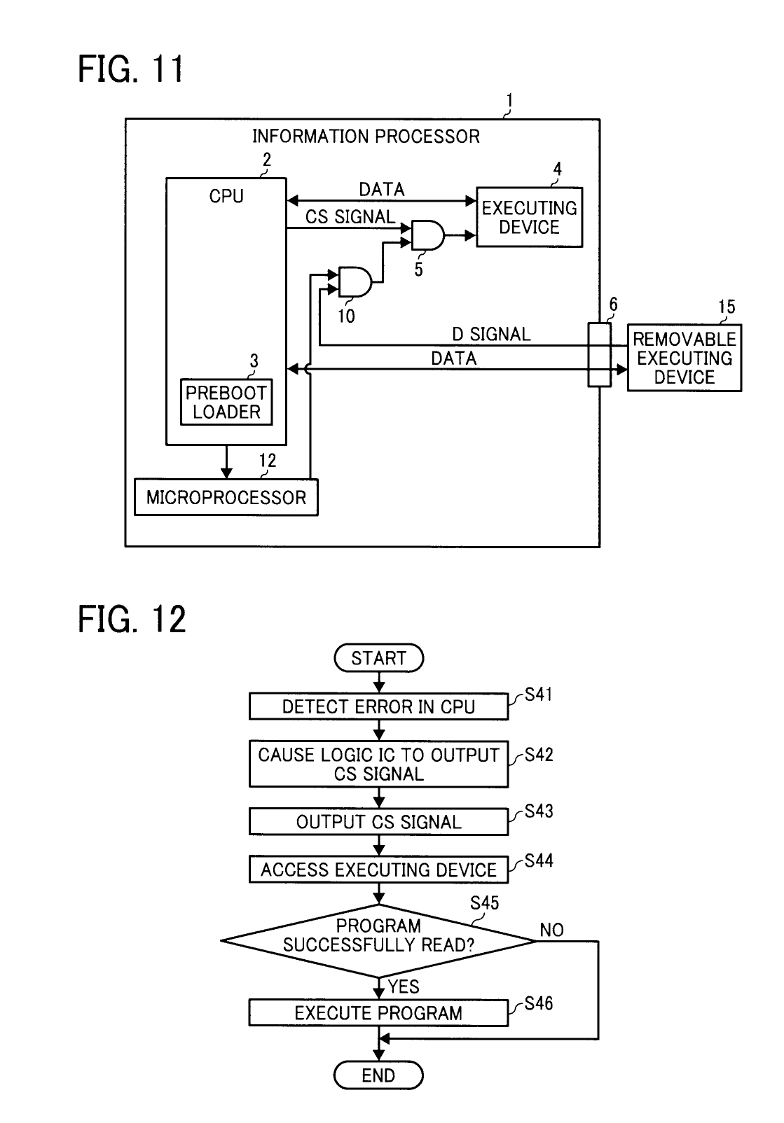

Referring now to FIGS. 11 and 12, one example of the information processor 1 is explained. FIG. 11 is a schematic block diagram illustrating a structure of the image processor 1. FIG. 12 is a flowchart illustrating operation of executing a program when the MFP 20 is turned on, performed by the information processor 1 of FIG. 11, according to an example embodiment of the present invention.

In any one of the above-described examples, even when the programs are successfully read from the removable executing device 15, the information processor 1 may not be able to execute the programs. For example, the programs may not be executable on the information processor 1. In such case, rather than prohibiting the information processor 1 to execute with the programs read from the executing device 4, it may be desirable in terms of user operability to execute the MFP 20 with the programs read from the executing device 4.

As illustrated in FIG. 11, the information processor 1 includes the CPU 2, the preboot loader 3 that is an internal function of the CPU 2, the executing device 4, the logic IC 5, and the connector 6. Through the connector 6, the removable executing device 15 is connected to the information processor 1. The information processor 1 further includes a logic IC 10 and a microprocessor 12.

The CPU 2, the preboot loader 3, the executing device 4, the logic IC 5, the connector 6, and the removable executing device 15 are substantially similar in function and operation to the CPU 2, the preboot loader 3, the executing device 4, the logic IC 5, the connector 6, and the removable executing device 15 of FIG. 2.

The logic IC 10 detects connection or disconnection of the removable executing device 15 through the connector 6. As the power of the MFP 20 is turned on, the logic IC 10 determines whether a detect (D) signal is output, which is the signal output from the connector 6 when the removable executing device 15 is connected to the connector 6. Further, the logic IC 10 determines whether a signal is output from the microprocessor 12, which indicates that the programs are successfully executed. When the signal indicating execution output from the microprocessor 12 is detected, the logic IC 10 outputs the D signal, which is received from the connector 6, to the logic IC 5 to instruct the logic IC 5 to prohibit the CS signal from being output to the executing device 4.

The microprocessor 12 receives a predetermined signal from the CPU 2, when the CPU 2 successfully executes the programs read from the removable executing device 15. When the CPU fails to execute the programs, the predetermined signal is not transmitted to the microprocessor 12.

More specifically, when the predetermined signal is not output from the CPU 2, the microprocessor 12 determines that the programs are not successfully executed, and does not output the signal indicating that the programs are executed, to the logic IC 10. When the signal indicating successful execution is not detected, the logic IC 10 does not output the D signal, which is received from the removable executing device 15, to the logic IC 5. The logic IC 5, which does not receive the D signal, determines that the removable executing device 15 is not connected, and outputs the CS signal to the executing device 4. This causes the preboot loader 3 to access the executing device 4 to read the programs from the executing device 4.

Referring now to FIG. 12, operation of executing a program when the power of the MFP 20 is turned on, performed by the information processor 1 of FIG. 11, is explained according to an example embodiment of the present invention. The operation of FIG. 12 may be performed when the operation of FIG. 3, 8, or 10 ends in error as the programs are not successfully read from the removable executing device 15. In another example, the operation of FIG. 12 may be performed when the programs read from the removable executing device 15 are not executable by the CPU 2. In such case, the CPU 2 does not output a signal indicating that execution of the programs read from the removable executing device 15 succeeded, to the microprocessor 12.

At S41, the microprocessor 12 determines that the signal indicating successful execution of the programs is not output from the CPU 2.

At S42, the microprocessor 12 does not output the signal indicating that the programs are executed to the logic IC 10. This prevents the logic IC 10 from outputting the D signal, which is received from the connector 6 when the removable executing device 15 is connected, to the logic IC 5. The logic IC 5, which is not input with the D signal, outputs the CS signal received from the CPU 2 to the executing device 4. In this manner, the CS signal, which is asserted to indicate selection of the executing device 4, is output to the executing device 4.

At S43, the preboot loader 3 outputs the CS signal indicating selection of the executing device 4 to the logic IC 5. The logic IC 5, which receives the CS signal, outputs the CS signal to the executing device 4.

At S44, the preboot loader 3, which can access the executing device 4, accesses the executing device 4 to read the programs stored therein.

At S45, the preboot loader 3 determines whether the programs to be executed by the CPU 2 are successfully read from the executing device 4. When it is determined that the programs are successfully read (“YES” at S45), the operation proceeds to S46. At S46, the CPU 2 executes the programs read from the executing device 4 to perform operations according to the programs, and the operation ends. When it is determined that the programs are not successfully read (“NO” at S45), the operation ends in error. In such case, the MFP 20 is not executed.

In case of performing the operation of FIG. 12 after the operation of FIG. 5 end in error, when the microprocessor 12 detects an error in reading or executing the programs stored in the removable executing device 15, the microprocessor 12 instructs the power IC 7 to start supplying electric power to the executing device 4, thus making the executing device 4 to be accessible from the preboot loader 3.

As described above referring to FIGS. 11 and 12, even when the CPU 2 fails in reading or executing the programs stored in the removable executing device 15, the CPU 2 may be caused to automatically execute with the programs stored in the executing device 4.

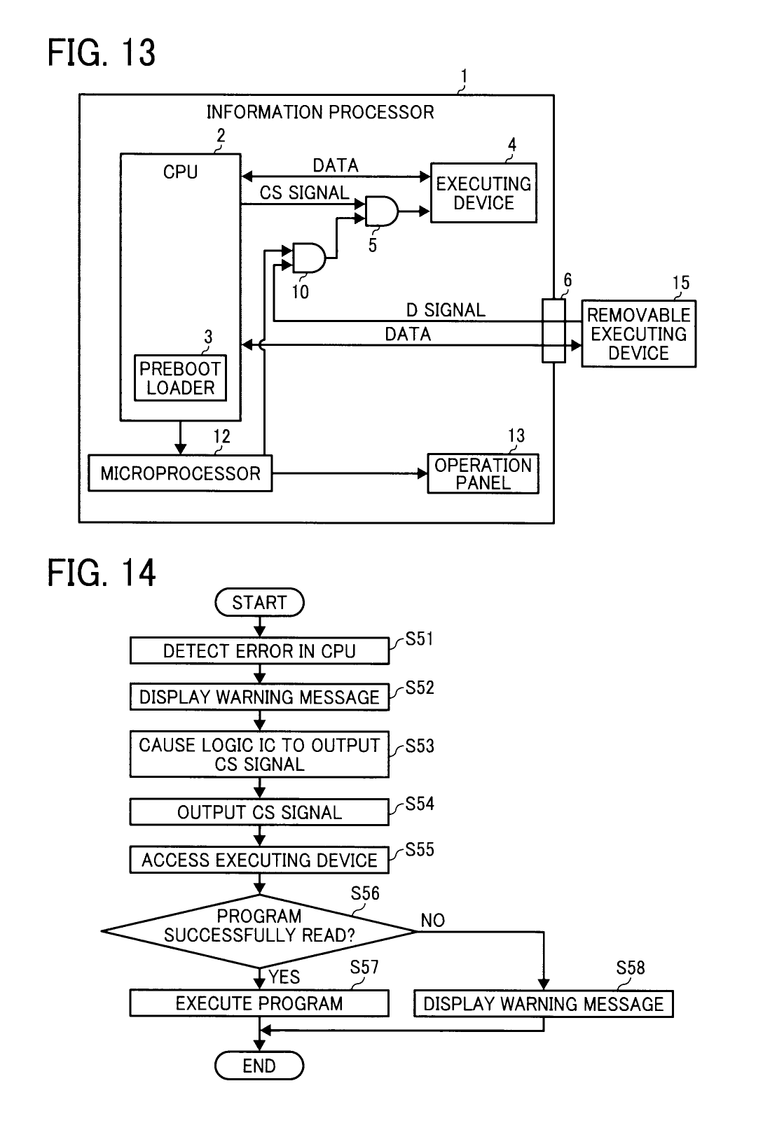

Referring now to FIGS. 13 and 14, one example of the information processor 1 is explained. FIG. 13 is a schematic block diagram illustrating a structure of the image processor 1. FIG. 14 is a flowchart illustrating operation of executing a program when the MFP 20 is turned on, performed by the information processor 1 of FIG. 13, according to an example embodiment of the present invention.

In any one of the above-described image processors 1 of FIGS. 2, 4, 6, 7, and 9, when the CPU 2 fails in executing the programs stored in the removable executing device 15, the information processor 1 may cause the MFP 2 to output notification to the user. With this notification, the user is able to instantly know that an error occurs, thus improving user operability.

The information processor 1 of FIG. 13 is substantially similar in function and operation of the information processor 1 of FIG. 11, except for the differences that include the addition of an operation panel 13. In FIG. 13, the operation panel 13 is shown as it is incorporated in the information processor 1, however, the operation panel 13 that is installed onto the MFP 20 is preferably used. The operation panel 13 displays notification, such as a warning message, to the user when the microprocessor 12 detects that the CPU 2 fails to execute the programs stored in the removable executing device 15.

Referring now to FIG. 14, operation of executing a program when the power of the MFP 20 is turned on, performed by the information processor 1 of FIG. 13, is explained according to an example embodiment of the present invention. The operation of FIG. 14 may be performed when the operation of FIG. 3, 8, or 10 ends in error as the programs are not read from the removable executing device 15, or the programs read from the removable executing device 15 are not executable by the CPU 2. In such case, the CPU 2 does not output a signal indicating that execution of the programs read from the removable executing device 15 succeeded, to the microprocessor 12.

At S51, the microprocessor 12 determines that the signal indicating successful execution of the programs is not output from the CPU 2.

At S52, the microprocessor 12 causes the operation panel 13 to display a warning message to notify the user that an error occurs in reading or executing the programs stored in the removable executing device 15.

At S53, the microprocessor 12 does not output the signal indicating that the programs are executed to the logic IC 10. This prevents the logic IC 10 from outputting the D signal, which is received from the connector 6 when the removable executing device 15 is connected, to the logic IC 5. The logic IC 5, which is not input with the D signal, outputs the CS signal received from the CPU 2 to the executing device 4. In this manner, the CS signal, which is asserted to indicate selection of the executing device 4, is output to the executing device 4.

At S54, the preboot loader 3 outputs the CS signal indicating selection of the executing device 4 to the logic IC 5. The logic IC 5, which receives the CS signal, outputs the CS signal to the executing device 4.

At S55, the preboot loader 3, which can access the executing device 4, accesses the executing device 4 to read the programs stored therein.

At S56, the preboot loader 3 determines whether the programs to be executed by the CPU 2 are successfully read from the executing device 4. When it is determined that the programs are successfully read (“YES” at S56), the operation proceeds to S57. At S57, the CPU 2 executes the programs read from the executing device 4 to perform operations according to the programs, and the operation ends. When it is determined that the programs are not successfully read (“NO” at S56), the operation proceeds to S58. At S58, the microprocessor 12 causes the operation panel 13 to display a warning message to the user to notify the user that an error occurs in executing the executing device 4, and the operation ends in error. In such case, the MFP 20 is not executed.

In case of performing the operation of FIG. 14 after the operation of FIG. 5 ends in error, when the microprocessor 12 detects an error in reading or executing the programs stored in the removable executing device 15, the microprocessor 12 instructs the power IC 7 to start supplying electric power to the executing device 4, thus making the executing device 4 to be accessible from the preboot loader 3.

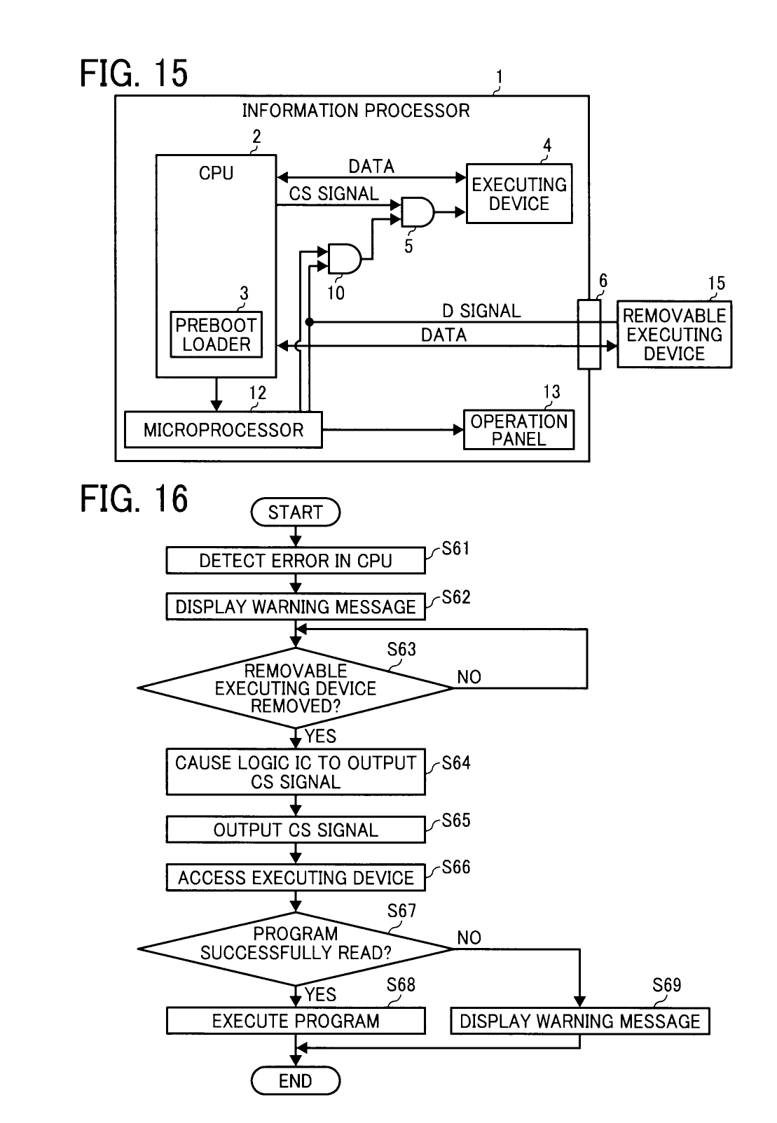

Referring now to FIGS. 15 and 16, one example of the information processor 1 is explained. FIG. 15 is a schematic block diagram illustrating a structure of the image processor 1. FIG. 16 is a flowchart illustrating operation of executing a program when the MFP 20 is turned on, performed by the information processor 1 of FIG. 15, according to an example embodiment of the present invention.

The information processor 1 of FIG. 15 is substantially similar in function and operation to the information processor 1 of FIG. 13, except for the difference that include the addition of a function that monitors the D signal indicating connection of the removable executing device 15 to output a monitoring result and that performs processing based on the monitoring result.

More specifically, in the information processor 1 of FIG. 15, when the microprocessor 12 detects that the CPU 2 fails in executing the programs read from the removable executing device 15, the microprocessor 12 determines whether the removable executing device 15 is disconnected from the connector 6, and starts operation of causing the CPU 2 to execute with the programs stored in the executing device 4 after it is determined that the removable executing device 15 is disconnected.

Referring now to FIG. 16, operation of executing a program when the power of the MFP 20 is turned on, performed by the information processor 1 of FIG. 15, is explained according to an example embodiment of the present invention. The operation of FIG. 16 may be performed when the operation of FIG. 3, 8, or 10 ends in error as the programs are not read from the removable executing device 15, or the programs read from the removable executing device 15 are not executable by the CPU 2. In such case; the CPU 2 does not output a signal indicating that execution of the programs read from the removable executing device 15 succeeded, to the microprocessor 12.

At S61, the microprocessor 12 determines that the signal indicating successful execution of the programs is not output from the CPU 2.

At S62, the microprocessor 12 causes the operation panel 13 to display a warning message to notify the user that an error occurs in reading or executing the programs stored in the removable executing device 15. Further, the warning message includes a message that requests the user to remove the removable executing device 15 from the MFP 20.

At S63, the microprocessor 12 determines whether the removable executing device 15 is removed from the MFP 20 by the user. More specifically, the microprocessor 12 monitors the D signal indicating connection of the removable executing device 15. When the D signal is not detected, the microprocessor 12 determines that the removable executing device 15 is removed from the MFP 20 (“YES” at S63), and the operation proceeds to S64. When the D signal indicating connection of the removable executing device 15 is not detected, the microprocessor 12 determines that the removable executing device 15 is not removed from the MFP 20 (“NO” at S63), and the operation repeats S63.

At S64, since the D signal is not output as the removable executing device 15 is disconnected, the logic IC 10 does not output the D signal to the logic IC 5. The logic IC 5, which is not input with the D signal, outputs the CS signal received from the CPU 2 to the executing device 4. In this manner, the CS signal, which is asserted to indicate selection of the executing device 4, is output to the executing device 4.

At S65, the preboot loader 3 outputs the CS signal indicating selection of the executing device 4 to the logic IC 5. The logic IC 5, which receives the CS signal, outputs the CS signal to the executing device 4.

At S66, the preboot loader 3, which can access the executing device 4, accesses the executing device 4 to read the programs stored therein.

At S67, the preboot loader 3 determines whether the programs to be executed by the CPU 2 are successfully read from the executing device 4. When it is determined that the programs are successfully read (“YES” at S67), the operation proceeds to S68. At S68, the CPU 2 executes the programs read from the executing device 4 to perform operations according to the programs, and the operation ends. When it is determined that the programs are not successfully read (“NO” at S67), the operation proceeds to S69. At S69, the microprocessor 12 causes the operation panel 13 to display a warning message to the user to notify the user that an error occurs in executing the executing device 4, and the operation ends in error. In such case, the MFP 20 is not executed.

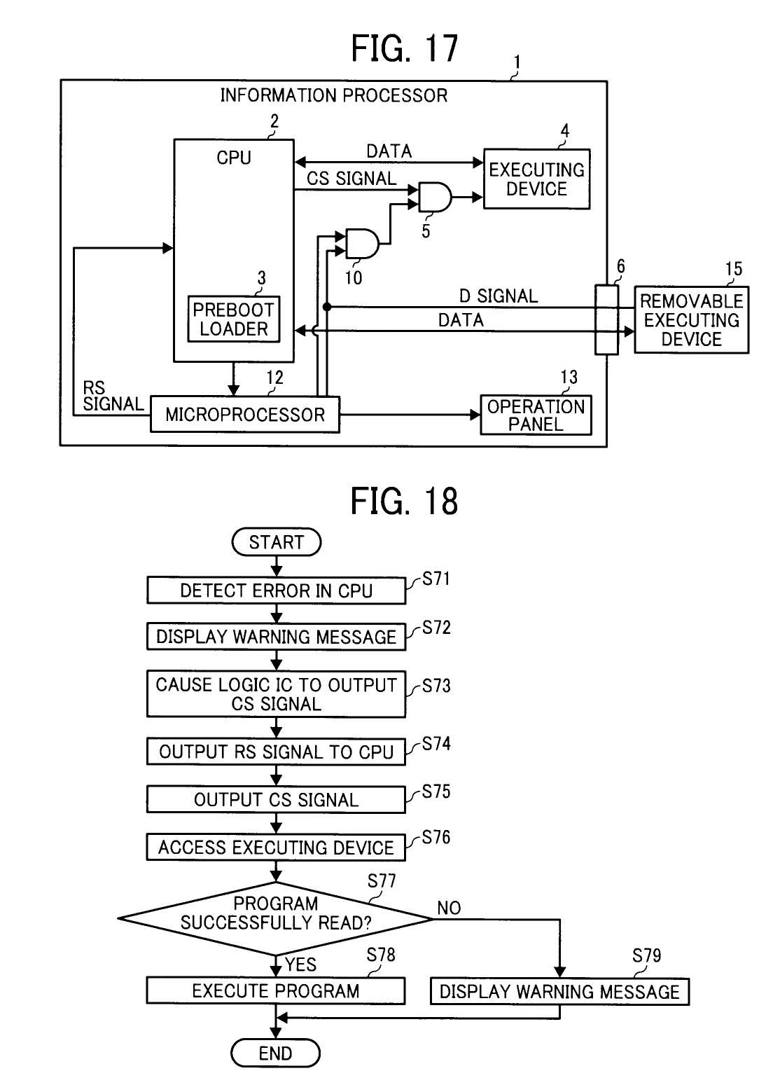

Referring now to FIGS. 17 and 18, one example of the information processor 1 is explained. FIG. 17 is a schematic block diagram illustrating a structure of the image processor 1. FIG. 18 is a flowchart illustrating operation of executing a program when the MFP 20 is turned on, performed by the information processor 1 of FIG. 17, according to an example embodiment of the present invention.

In the information processor 1 of any one of FIGS. 2, 4, 6, 7, 9, 11, 13, and 15, when the programs are not read from the removable executing device 15 or the programs read from the removable executing device 15 are not executable, the preboot loader 3 accesses the executing device 4 based on its settings information indicating an order of accessing the executing devices. More specifically, if the preboot loader 3 fails to read or execute the programs stored in the removable executing device 15, which is set as an executing device to be secondly accessed, the preboot loader 15 is caused to read the programs stored in the executing device 4, which is set as an executing device to be firstly accessed. If the preboot loader 15 is not able to change the executing device to be firstly accessed by error, the MFP 20 is not able to execute with the programs stored in the executing device 4 when the programs stored in the removable executing device 15 are not readable or executable. In view of this, when the programs stored in the removable executing device 15 are not readable or executable, the CPU 2 is restarted to reset the preboot loader 3 to be in the initial settings, thus causing the preboot loader 3 to firstly access the executing device 4.

The information processor 1 of FIG. 17 is substantially similar in function and operation to the information processor 1 of FIG. 15, except for the differences that include the elimination of the function that monitors the D signal of the removable executing device 15, and the addition of a function that transmits a reset (RS) signal to the CPU 2 to restart the CPU 2. As the CPU 2 is restarted, the preboot loader 3 is reset to be in the initial settings.

Referring now to FIG. 18, operation of executing a program when the power of the MFP 20 is turned on, performed by the information processor 1 of FIG. 17, is explained according to an example embodiment of the present invention. The operation of FIG. 18 may be performed when the operation of FIG. 3, 5, 8, or 10 ends in error as the programs are not read from the removable executing device 15, or the programs read from the removable executing device 15 are not executable by the CPU 2. In such case, the CPU 2 does not output a signal indicating that execution of the programs read from the removable executing device 15 succeeded, to the microprocessor 12. Further, in this example, it is assumed that the preboot loader 3 is not able to access the executing device 4, which is the executing device to be firstly accessed, after accessing the removable executing device 15.

At S71, the microprocessor 12 determines that the signal indicating successful execution of the programs is not output from the CPU 2.

At S72, the microprocessor 12 causes the operation panel 13 to display a warning message to notify the user that an error occurs in reading or executing the programs stored in the removable executing device 15. The warning message further includes a message indicating that the CPU 2 is restarted.

At S73, the microprocessor 12 does not output the signal indicating that the programs are executed to the logic IC 10. This prevents the logic IC 10 from outputting the D signal, which is received from the connector 6 when the removable executing device 15 is connected, to the logic IC 5. The logic IC 5, which is not input with the D signal, outputs the CS signal received from the CPU 2 to the executing device 4.

At S74, the microprocessor 12 outputs the reset (RS) signal to the CPU 2 to restart the CPU 2. As the CPU 2 is restarted, the preboot loader 3 is reset to the initialized state. This causes the CPU 2 to output the CS signal indicating selection of the executing device 4 to the logic IC 5, as the executing device 4 is set as the executing device to be firstly accessed.

At S75, the preboot loader 3 outputs the CS signal indicating selection of the executing device 4 to the logic IC 5.

At S76, as the logic IC 5, which receives the CS signal, outputs the executing device 4, the preboot loader 3 accesses the executing device 4 to read the programs stored therein.

At S77, the preboot loader 3 determines whether the programs to be executed by the CPU 2 are successfully read from the executing device 4. When it is determined that the programs are successfully read (“YES” at S77), the operation proceeds to S78. At S78, the CPU 2 executes the programs read from the executing device 4 to perform operations according to the programs, and the operation ends. When it is determined that the programs are not successfully read (“NO” at S77), the operation proceeds to S79. At S79, the microprocessor 12 causes the operation panel 13 to display a warning message to the user to notify the user that an error occurs in executing the executing device 4, and the operation ends in error. In such case, the MFP 20 is not executed.

In the above-described examples, it is assumed that the MFP 20 is implemented by a copier. Alternatively, any other type of image forming apparatus may be implemented as long as any one of the above-described information processors 1 is incorporated therein including, for example, a facsimile, printer, copier, etc.

Numerous additional modifications and variations are possible in light of the above teachings. It is therefore to be understood that within the scope of the appended claims, the disclosure of the present invention may be practiced otherwise than as specifically described herein.

With some embodiments of the present invention having thus been described, it will be obvious that the same may be varied in many ways. Such variations are not to be regarded as a departure from the spirit and scope of the present invention, and all such modifications are intended to be included within the scope of the present invention.

For example, elements and/or features of different illustrative embodiments may be combined with each other and/or substituted for each other within the scope of this disclosure and appended claims.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory cards, ROM (read-only-memory), etc.

Alternatively, any one of the above-described and other methods of the present invention may be implemented by ASIC, prepared by interconnecting an appropriate network of conventional component circuits or by a combination thereof with one or more conventional general purpose microprocessors and/or signal processors programmed accordingly.

In one example, the present invention may reside in an information processing device including: first storing means for storing therein a program; reading means for accessing the first storing means to read the program from the first storing means when a power of the information processing device is turned on; and controlling means for executing the program read by the reading means to perform operations. The information processing device further includes: connecting means for connecting the information processing device with second storing means for storing therein a program; and access restricting means for causing the first storing means to be inaccessible from the reading means when it is detected that the second storing means is connected to the connecting means as the power of the information processing device is turned on. When the first storing means is inaccessible from the reading means, the reading means accesses the second storing means connected to the connecting means to read the program from the second storing means.

For example, the first storing means corresponds to the executing device. The second storing means corresponds to the removable executing device. The reading means corresponds to a preboot loader. The controlling means corresponds to a processor such as a CPU. The connecting means corresponds to a connector.

In one example, the access restring means causes the first storing means to be inaccessible by prohibiting output of a signal for accessing to the first storing means. When the access restricting means detects that the second storing means is connected to the connecting means when the power of the information processing device is turned on, a signal for accessing the first storing means that is output from the reading means is prevented from being output to the first storing means to cause the first storing means to be inaccessible from the reading means. For example, the access restring means corresponds to a logic IC 5, which controls output of a chip select signal received from the preboot loader of the CPU.

In another example, the access restring means causes the first storing means to be inaccessible by cutting off electric power supply to the first storing means. The access restricting means cuts off electric power supply to the first storing means to cause the first storing means to be inaccessible from the reading means, when it is detected that the second storing means is connected to the connecting means as the power is turned on. For example, the access restricting means corresponds to a logic 7, which controls electric power supply to the first storing means.

The information processing device further includes means for preventing the signal for accessing the first storing means that is output from the reading means, from being output to the first storing means, when the electric power supply to the first storing means is cut off. For example, the logic 7 is provided with a buffer 8.

The information processing device further includes detect signal controlling means for determining whether the second storing means is provided by an authorized user to generate a determination result, and controlling output of the detect signal to the access restricting means based on the determination result.

In one example, the information processing device further includes switching means for detecting whether a write protect of the second storing means is set to on to generate a detection result when the power of the information processing device is turned on, and switching between a valid value and an invalid value of the access restricting means based on the detection result. When the write protect of the second storing means is set to on, the switching means switches the access restring means to valid to cause the access restricting means to restrict access to the first storing means. When the write protect is set to off, the switching means switches the access restricting means to invalid to cause the access restricting means to allow access to the first storing means. For example, the switching means corresponds to a logic IC 9, which controls output of a detect signal to the logic IC 5, based on a WP signal.

In another example, the information processing device further includes switching means for detecting whether a user input selecting a specific operation key is received to generate a detection result when the power of the information processing device is turned on, and switching between a valid value and an invalid value of the access restricting means based on the detection result. When the user input selecting a specific operation key is received, the switching means switches the access restring means to valid to cause the access restricting means to restrict access to the first storing means. When the user input selecting a specific operation key is not received, the switching means switches the access restricting means to invalid to cause the access restricting means to allow access to the first storing means. For example, the switching means corresponds to a logic IC 10, which controls output of a detect signal to the logic IC 5, based on a signal indicating selection of a specific operation key.

The information processing device further includes: detect signal controlling means for determining whether the program is successfully read or executed from the second executing device to generate a determination result, and controlling output of the detect signal to the access restricting means based on the determination result. When the determination result indicates that the program is not successfully read or executed from the second executing device, the means prohibits the detect signal from being output to the access restricting means to cause the first storing means to be accessible by the reading means. The reading means accesses the first storing means to read the program stored therein, when the first storing means is accessible. For example, the detect signal controlling means corresponds to the logic IC 10 and a microprocessor 12.

The information processing device further includes: restarting means for restarting the reading means, when the determination result indicates that the program is not successfully read or executed from the second executing device. For example, the restarting means corresponds to the microprocessor 12.

The information processing device further includes: notifying means for outputting a warning to the user, when the determination result indicates that the program is not successfully read or executed from the second executing device. For example, the notifying means corresponds to an operation panel 13.

In one example, the present invention may reside in an image forming apparatus including any one of the above-described information processing devices.

In one example, the present invention may reside in a method of executing an information processing device including a processor and a first executing device that stores therein a program. The method includes: outputting a select signal indicating selection of the first executing device, which causes the processor to firstly access the first executing device to read the program from the first executing device when a power of the information processing device is turned on; determining whether a second executing device is electrically connected with the information processing device, the second executing device storing therein a program; outputting a detect signal indicating connection of the second executing device when the second executing device is connected; preventing the first executing device from receiving the select signal to cause the first executing device to be inaccessible from the processor; and causing the processor to access the second executing device to read the program from the second executing device for execution by the processor.

In another example, the present invention may reside in a recording medium storing a plurality of instructions which, when executed by a processor, cause the processor to perform any one of the above-described methods of executing an information processing device.

What is claimed is:

1. An information processing device, comprising:
a first executing device that stores therein a program;
a processor to output a select signal indicating selection of the first executing device, which causes the processor to firstly access the first executing device to read the program from the first executing device when a power of the information processing device is turned on;
a connector to electrically connect the information processing device with a second executing device and to output a detect signal indicating connection of the second executing device when the second executing device is connected, the second executing device storing therein a program;
wherein, when the detect signal indicating connection of the second executing device being output from the connector is detected, the first executing device is prevented from receiving the select signal output from the processor to cause the first executing device to be inaccessible from the processor, and
the processor accesses the second executing device to read the program from the second executing device for execution by the processor.

2. The information processing device of claim 1, further comprising:
a first integrated circuit to receive the select signal indicating selection of the first executing device from the processor, and to output the select signal to the first executing device,
wherein, when the detect signal indicating connection of the second executing device being output from the connector is detected, the first integrated circuit prevents the select signal from being output to the first executing device to cause the first executing device to be inaccessible from the processor.

3. The information processing device of claim 2, further comprising:
a second integrated circuit to detect a write protect signal indicating that a write protect of the second executing device is set to on when the power of the information processing device is turned on,
wherein, when both of the detect signal indicating connection of the second executing device and the write protect signal indicating the write protect of the second executing device are detected, the second integrated circuit allows the detect signal to be output through the second integrated circuit to the first integrated circuit to cause the first executing device to be inaccessible from the processor.

4. The information processing device of claim 2, further comprising:
an operation device provided with a plurality of operation keys;
a second integrated circuit to detect an input signal indicating input of a specific operation key of the plurality of operation keys when the power of the information processing device is turned on,
wherein, when both of the detect signal indicating the connection of the second executing device and the input signal indicating input of a specific operation key are detected, the second integrated circuit allows the detect signal to be output through the second integrated circuit to the first integrated circuit to cause the first executing device to be inaccessible from the processor.

5. The information processing device of claim 2, further comprising:
a second integrated circuit to detect an execution signal indicating that the program is successfully read or executed from the second executing device,
wherein, when the execution signal indicating that the program is successfully read or executed from the second executing device is not detected, the second integrated circuit prevents the detect signal from being output through the second integrated circuit to the first integrated circuit to cause the first executing device to be accessible, and
the processor accesses the first executing device to read the program from the first executing device for execution by the processor.

6. The information processing device of claim 5, further comprising:
an operation panel provided with a display,
wherein, when the execution signal indicating that the program is successfully read or executed from the second executing device is not detected, the processor causes the operation panel to display a warning message, the warning message including a message that requests a user to disconnect the second executing device from the information processing device.

7. The information processing device of claim 6, wherein
the second integrated circuit determines whether the second executing device is disconnected from the information processing device based on the detect signal, and
when the second integrated circuit determines that the detect signal indicating the connection of the second executing device is detected, the second integrated circuit causes the processor to keep displaying the message that requests a user to disconnect the second executing device.

8. The information processing device of claim 5, wherein
when the execution signal indicating that the program is successfully read or executed from the second executing device is not detected, the processor is restarted to output the select signal indicating selection of the first executing device to cause the processor to access the first executing device to read the program from the first executing device for execution.

9. The information processing device of claim 1, further comprising:
an integrated circuit to control electric power supply to the first executing device,
wherein, when the detect signal indicating connection of the second executing device being output from the connector is detected, the integrated circuit cuts off electric power supply to the first executing device to cause the first executing device to be inaccessible from the processor.

10. The information processing device of claim 9, further comprising:
a buffer circuit provided between the processor and the first executing device and to prevent electric currents from flowing into the first executing device when the electric power supply to the first executing device is cut off.

11. An image forming apparatus, comprising:
the information processing device of claim 1.

12. An information processing device, comprising:
first storing means for storing therein a program;
reading means for firstly accessing the first storing means to read the program from the first storing means when a power of the information processing device is turned on;
controlling means for executing the program read by the reading means;
connecting means for electrically connecting the information processing device with second storing means, and outputting a detect signal indicating connection of the second storing means when the second storing means is connected, the second storing means storing therein a program;
access restricting means for causing the first storing means to be inaccessible from the reading means when the detect signal indicating connection of the second storing means being output from the connecting means is detected when the power of the information processing device is turned on,
wherein, when the first storing means is inaccessible from the reading means, the reading means accesses the second storing means to read the program from the second storing means for execution by the controlling means.

13. The information processing device of claim 12, wherein
the reading means outputs a select signal indicating selection of the first storing means, which causes the reading means to firstly access the first storing means, and
the access restricting means receives the select signal indicating selection of the first storing means from the reading means, and prevents the select signal from being output to the first storing means to cause the first storing means to be inaccessible from the reading means when the detect signal indicating connection of the second storing means being output from the connecting means is detected.

14. The information processing device of claim 12, wherein
the access restricting means cuts off electric power supply to the first storing means to cause the first storing means to be inaccessible from the reading means, when the detect signal indicating connection of the second storing means being output from the connecting means is detected.

15. The information processing device of claim 12, further comprising:
detect signal controlling means for determining whether the second storing means is provided by an authorized user when the power of the information processing device is turned on to generate a determination result, and controlling output of the detect signal to the access restricting means based on the determination result,
wherein, when the determination result indicates that the second storing means is provided by the authorized user, the detect signal controlling means allows the detect signal to be output to the access restricting means, and
when the determination result indicates that the second storing means is not provided by the authorized user, the detect signal controlling means prohibits the detect signal from being output to the access restricting means.

16. The information processing device of claim 15, wherein the detect signal controlling means generates the determination result indicating whether the second storing means is provided by the authorized user, based on whether a write protect signal indicating that a write protect of the second storing means is set to on is output when the power of the information processing device is turned on.

17. The information processing device of claim 12, further comprising:
detect signal controlling means for determining whether the program is successfully read or executed from the second executing device to generate a determination result, and controlling output of the detect signal to the access restricting means based on the determination result
wherein, when the determination result indicates that the program is not successfully read or executed from the second executing device, the detect signal controlling means prohibits the detect signal from being output to the access restricting means, and
the reading means accesses the first storing means to read the program from the first storing means.

18. The information processing device of claim 17, further comprising:
restarting means for restarting the controlling means to cause the reading means to access the first storing means, when the determination result indicates that the program is not successfully read or executed from the second executing device.

19. A method of executing an information processing device including a processor and a first executing device that stores therein a program, the method comprising:
outputting a select signal indicating selection of the first executing device, which causes the processor to firstly access the first executing device to read the program from the first executing device when a power of the information processing device is turned on;
determining whether a second executing device is electrically connected with the information processing device, the second executing device storing therein a program;
outputting a detect signal indicating connection of the second executing device when the second executing device is connected;
preventing the first executing device from receiving the select signal to cause the first executing device to be inaccessible from the processor, when the outputting outputs the detect signal indicating connection of the second executing device; and
causing the processor to access the second executing device to read the program from the second executing device for execution by the processor.
